(19) United States
(12) Patent Application Publication
(10) Pub. No.: US 2025/0225167 A1
(43) Pub. Date: Jul. 10, 2025

(54) METHOD AND SYSTEM FOR SUMMARIZING TEXT ARTICLES OF DOCUMENTS

(71) Applicant: HCL Technologies Limited, New Delhi (IN)

(72) Inventors: Sujit Malakar, Noida (IN); Harikrishna C Warrier, Bengaluru (IN); Yogesh Gupta, Noida (IN)

(21) Appl. No.: 19/007,610

(22) Filed: Jan. 2, 2025

(30) Foreign Application Priority Data
Jan. 10, 2024 (IN) 202411001840

(51) Int. Cl. G06F 16/34; G06F 16/3332; G06F 16/353

(52) U.S. Cl. CPC G06F 16/345; G06F 16/3334; G06F 16/353

(57) ABSTRACT

A system and method for summarizing text articles of documents is disclosed. The method includes receiving a text article from a document. The text article may include a plurality of sentences. The method further includes extracting one or more keywords from the plurality of sentences; identifying a set of additional keywords corresponding to the one or more keywords; semantically scoring the plurality of sentences; ranking each of the plurality of sentences based on the semantical scoring; performing a contextual classification to select a set of sentences from the plurality of sentences based on one of the semantically scoring or the ranking; clustering each of the set of sentences based on one of the semantic scoring or embedding to generate a summarized text for each cluster; and generating a consolidated summarized text based on the clustering.

### TECHNICAL FIELD

This disclosure relates generally to text summarization. More specifically, the invention relates to a method and a system for summarizing text articles of documents.

### BACKGROUND

Text summarization using artificial intelligence plays a crucial role in distilling information from large articles. At a high level, text summarization involves presenting a model with a set of input sentences, which then generates a summarized output. Currently, the text summarization relies heavily on models such as BERT and advanced language models such as LLM. While these models demonstrate impressive capabilities, they encounter two main challenges when dealing with a task of text summarization.

The primary challenge may be to identify a right set of sentences which needs to be given as input for summarization (referred to as screening of sentences). The secondary challenge may be to identify an optimal number of sentences so that the summarization may be of reasonable size (referred to as clustering of sentences), this may particularly be a case when the size of a document is huge. Therefore, to summarize any text, it may be important that the right set of sentences are given as input to the summarization model, so that the quality of the summary may be as expected. Additionally, if many sentences are given as input for summarization, it may impact both time and cost of summarization. Hence, sentences need to be optimized, but at the same time no or minimal context should be lost.

Therefore, to overcome these challenges there exists a need to develop a text summarization method and system that may be capable of identifying a right set of sentences and an optimal set of sentences without affecting the quality of the summary.

### SUMMARY OF INVENTION

In one embodiment, a method for summarizing text articles of documents is disclosed. The method may include receiving a text article from a document. The text article may include a plurality of sentences. The method may further include extracting one or more keywords from the plurality of sentences based on a keyword extraction algorithm. The method may further include identifying, from each word of the plurality of sentences, a set of additional keywords corresponding to the one or more keywords based on one of a distance calculation, a similarity algorithm, a vectorization, or a word embedding. The method may further include semantically scoring the plurality of sentences based on a weight of each set of the additional keywords and a frequency of each word in the plurality of sentences. The method may further include ranking each of the plurality of sentences based on the semantical scoring. The method may further include performing a contextual classification to select a set of sentences from the plurality of sentences based on one of the semantically scoring or the ranking. The method may further include clustering each of the set of sentences based on one of the semantic scoring or embedding to generate a summarized text for each cluster. The method may further include generating a consolidated summarized text based on the clustering.

In another embodiment, a system for summarizing text articles of documents is disclosed. The system may include a processor and a memory communicatively coupled to the processor. The memory may store processor-executable instructions, which, on execution, may cause the processor to receive a text article from a document. The text article may include a plurality of sentences. The processor-executable instructions, on execution, may further cause the processor to extract one or more keywords from the plurality of sentences based on a keyword extraction algorithm. The processor-executable instructions, on execution, may further cause the processor to identify, from each word of the plurality of sentences, a set of additional keywords corresponding to the one or more keywords based on one of a distance calculation, a similarity algorithm, a vectorization, or a word embedding. The processor-executable instructions, on execution, may further cause the processor to semantically score the plurality of sentences based on a weight of each set of the additional keywords and a frequency of each word in the plurality of sentences. The processor-executable instructions, on execution, may further cause the processor to rank each of the plurality of sentences based on the semantical scoring. The processor-executable instructions, on execution, may further cause the processor to perform a contextual classification to select a set of sentences from the plurality of sentences based on one of the semantically scoring or the ranking. The processor-executable instructions, on execution, may further cause the processor to cluster each of the set of sentences based on one of the semantic scoring or embedding to generate a summarized text for each cluster. The processor-executable instructions, on execution, may further cause the processor to generate a consolidated summarized text based on the clustering.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals.

FIG. 1 is an environment diagram illustrating a system for summarizing text articles of documents, in accordance with an embodiment.

FIG. 2 is a block diagram illustrating various modules within a memory of a text summarizing device configured to summarize text articles of documents, in accordance with an embodiment.

FIG. 3 is a block diagram of a process flow for screening of sentences, in accordance with an embodiment.

FIG. 4 illustrates an exemplary table depicting identification of affinity keywords from a text article, in accordance with an exemplary embodiment.

FIG. 5 illustrates an exemplary table depicting identification of semantic significance keywords from a text article, in accordance with an exemplary embodiment.

FIG. 6 illustrates an exemplary table depicting identification of similar keywords from a text article, in accordance with an exemplary embodiment.

FIG. 7 illustrates an exemplary table depicting semantically scoring of sentences, in accordance with an exemplary embodiment.

FIG. 8 is a block diagram of a process flow for clustering of sentences based on semantic scoring, in accordance with an embodiment.

FIG. 9 is a block diagram of a process flow for clustering of sentences based on embedding, in accordance with an embodiment.

FIG. 10 is a flowchart of a method for summarizing text articles of documents, in accordance with an embodiment.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

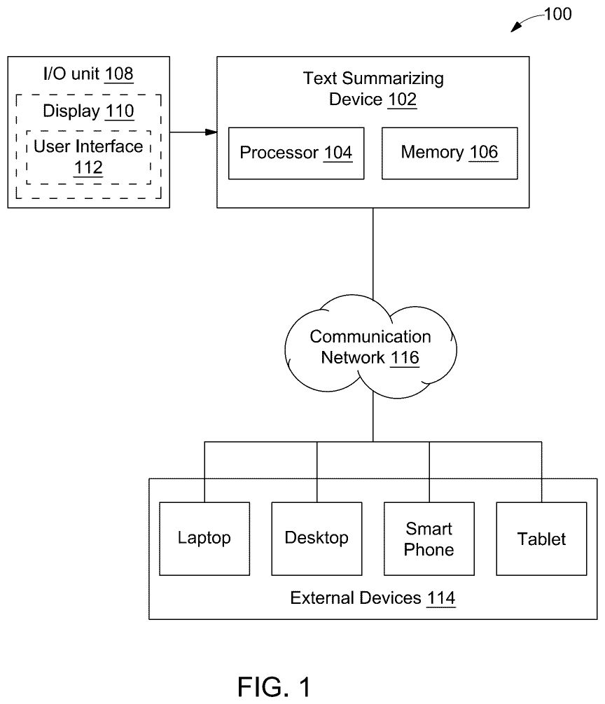

Referring now to FIG. 1, is an environment diagram of a system 100 for summarizing text articles of documents is illustrated, in accordance with an embodiment. The system 100 may include a text summarizing device 102 that may be responsible for summarizing text articles of documents. The text article may be a text of any article that may consist of sentences and words. Other than sentences and words, tables, and figures present in the document may also be broken down to phrases and words for meaningful interpretations. Examples of the text summarizing device 102 may include, but may not be limited to a server, a desktop, a laptop, a notebook, a tablet, a smartphone, a mobile phone, an application server, or the like.

The text summarizing device 102 may include a processor 104 that is communicatively coupled to a memory 106 which may be a non-volatile memory or a volatile memory. Examples of non-volatile memory may include, but may not be limited to a flash memory, a Read Only Memory (ROM), a Programmable ROM (PROM), Erasable PROM (EPROM), and Electrically EPROM (EEPROM) memory. Examples of volatile memory may include, but may not be limited to Dynamic Random Access Memory (DRAM), and Static Random-Access Memory (SRAM).

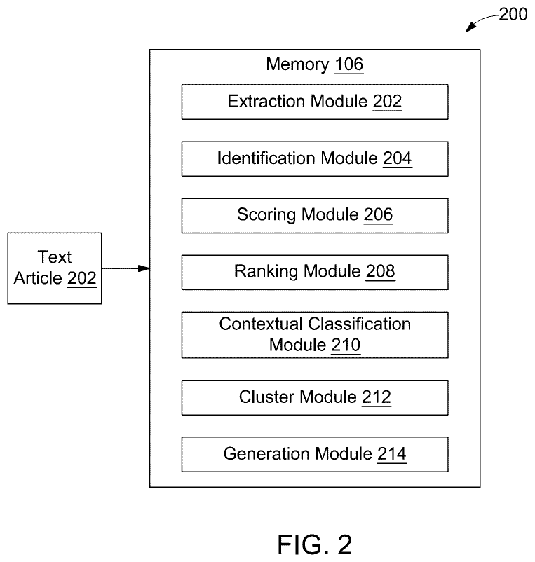

The memory 106 may store instructions that, when executed by the processors 104, cause the processor 104 to summarize the text articles of documents. As will be described in greater detail in conjunction with FIGS. 2-10, the text summarizing device 102 in conjunction with the processor 104 may receive a text article from a document, the text article may include a plurality of sentences. The text summarizing device 102 may further extract one or more keywords from the plurality of sentences based on a keyword extraction algorithm. The text summarizing device 102 may further identify, from each word of the plurality of sentences, a set of additional keywords corresponding to the one or more keywords based on one of a distance calculation, a similarity algorithm, a vectorization, or a word embedding techniques. The text summarizing device 102 may further semantically score the plurality of sentences based on a weight of each set of the additional keywords and a frequency of each word in the plurality of sentences. The text summarizing device 102 may further rank each of the plurality of sentences based on the semantically scoring. The text summarizing device 102 may further perform a contextual classification to select a set of sentences from the plurality of sentences based on one of the semantically scoring or the ranking. The text summarizing device 102 may further cluster each of the set of sentences based on one of the semantic scoring or embedding to generate a summarized text for each cluster. The text summarizing device 102 may further generate a consolidated summarized text based on the clustering.

The memory 106 may also store various data (e.g., textual information, metadata, summarization models, weights, training datasets, summarization output, and other relevant datasets) that may be captured, processed, and/or required by the text summarizing device 102. The memory 106 may further include various modules that enable the text summarizing device 102 to summarize the text articles of documents. These modules are explained in detail in conjunction with FIG. 2.

The text summarizing device 102 may interact with a user via an input/output unit 108. In particular, the text summarizing device 102 may interact with the user via a user interface 112 accessible via the display 110. Thus, for example, in some embodiments, the user interface 112 may enable the user to upload the text article that needs to be summarized in a repository or the memory 106. Further, in some embodiments, the text summarizing device 102 may render result (e.g., a summarized text article) to end-user via the user interface 112.

The system 100 may also include one or more external devices 114. In some embodiments, the summarizing device 102 may interact with the one or more external devices 114 over a communication network 116 for sending or receiving various data. Examples of the external devices 114 may include, but may not be limited to, computer, tablet, smartphone, and laptop. The communication network 116, for example, may be any wired or wireless network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS).

Referring now to FIG. 2, a block diagram 200 of various modules within the memory 106 of summarizing device 102 configured to summarize text articles is illustrated, in accordance with some embodiments of the present disclosure. The memory 106 includes an extraction module 204, an identification module 206, a scoring module 208, a ranking module 210, a contextual classification module 212, a clustering module 214, and a generation module 216.

In order to summarize text articles, initially, a text article 202 from a document may be received via the input/output unit 108. In particular, the summarizing device 102 may interact with the user via the user interface 112 accessible via the display 110. In some embodiments, the user interface 112 may enable the user to navigate and choose specific text article from their local storage or the memory 106 that the user wishes to summarize. The text article 202 may include a plurality of sentences. The text article 202 may be, for example, a research paper, news article, legal document, scientific manuscript, blog post, or any other form of written content that the user intends to summarize using the text summarizing device 102.

Once the text article 202 is received, the extraction module 204 may extract one or more keywords from the plurality of sentences. The one or more keywords are important words which indicates context of a particular document. The one or more keywords are domain specific, and depending on the domain of the document, the one or more keywords may be extracted or identified. The one or more keywords may be extracted based on a keyword extraction algorithm.

Further, the identification module 206 may identify, from each word of the plurality of sentences, a set of additional keywords corresponding to the one or more keywords based on one of a distance calculation, a similarity algorithm, a vectorization, or a word embedding techniques. The set of additional keywords may include a plurality of affinity words, a plurality of semantically significant words, and a plurality of similar words. The set of additional keywords may provide additional information that may not be captured by the one or more keywords. In particular, affinity keywords and semantic significance words may be identified through distance calculations and similarity algorithms, along with vectorization while similar keywords are generated using text embedding models.

Further, the scoring module 208 may semantically score the plurality of sentences based on a weight of each set of the additional keywords and a frequency of each word in the plurality of sentences. In some embodiments, in order to semantically score the plurality of sentences, the scoring module 208 may initially assign a weight to each of the set of additional keywords. Based on the weight assigned to each of the set of additional keywords, the scoring module 208 may further calculate a semantic score for each sentence.

Once the scooring is done, the ranking module 210 may be configured to rank each of the plurality of sentences based on the semantically scoring. Further, the contextual classification module 212 may perform a contextual classification to select a set of sentences from the plurality of sentences based on one of the semantically scoring or the ranking. The contextual classification may be one of a rule-based classification or a model-based classification.

In some embodiments, performing the contextual classification to select the set of sentences based on the rule-based classification comprises for each unlabelled data, identifying the plurality of sentences having a rank greater than a predefined threshold; and selecting a set of sentences based on the identifying. The set of sentences may be selected with the rank greater than the predefined threshold.

In some embodiments, the contextual classification module 212, when employing a rule-based classification approach for each unlabelled data, involves the identification of plurality of sentences. In particular, the contextual classification module 212 may identify the plurality of sentences with a rank greater than a predefined threshold. Based on identification, the contextual classification module 212 may select a set of sentences from the plurality of sentences. The set of sentences may be selected with the rank greater than the predefined threshold.

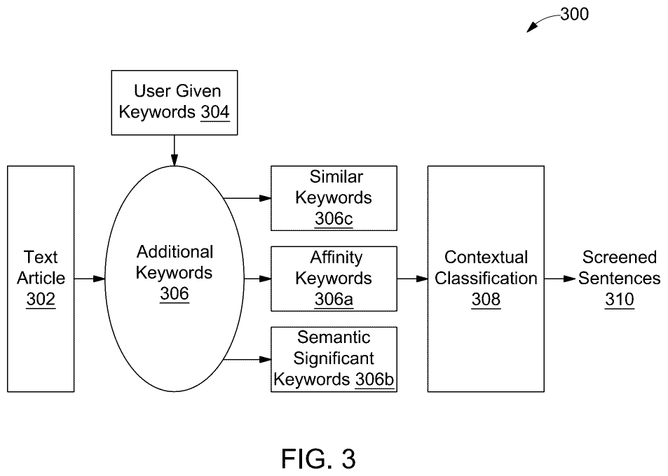

In an alternative embodiment, the contextual classification module 212, when employing a model-based classification approach for each labelled data, involves training of a model-based classification model based on the one or more keywords and the additional set of keywords. Subsequently, the contextual classification module 212 utilizes the trained model-based classification model to select a set of sentences. This process is further explained in conjunction with FIG. 3.

Further, the clustering module 214 may cluster each of the set of sentences based on one of the semantic scoring or embedding to generate a summarized text for each cluster. In order to cluster the set of sentences based on the semantic scoring, the clustering module 214 may identify one or more sentences within the set of sentences having relevant semantic scores. Based on the identifying, the clustering module 214 may group each of the one or more sentences into a separate cluster. Each of the separate cluster may include the one or more sentences with a corresponding relevant semantic scores.

Additionally, to cluster the set of sentences based on the embedding, the clustering module 214 may identify one or more sentences within the set of sentences having relevant embeddings. Based on the identifying, the clustering module 214 may group each of the one or more sentences into a separate cluster. Each of the separate cluster may include the one or more sentences with a corresponding relevant embeddings.

The generation module 216 may generate a consolidated summarized text based on the clustering. In a more elaborative way, to generate the consolidated summarized text, initially the generation module 216 may generate a summarized text for each of the separate cluster. Further, the generation module 216 may concatenate the summarized text of each of the separate cluster to obtain a consolidated summarized text.

It should be noted that all such aforementioned modules 204-216 may be represented as a single module or a combination of different modules. Further, as will be appreciated by those skilled in the art, each of the modules 204-216 may reside, in whole or in parts, on one device or multiple devices in communication with each other. In some embodiments, each of the modules 204-216 may be implemented as dedicated hardware circuit comprising custom application-specific integrated circuit (ASIC) or gate arrays, off-the-shelf semiconductors such as logic chips, transistors, or other discrete components. Each of the modules 204-216 may also be implemented in a programmable hardware device such as a field programmable gate array (FPGA), programmable array logic, programmable logic device, and so forth. Alternatively, each of the modules 204-216 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

Referring now to FIG. 3, a block diagram of a process flow 300 for screening of sentences is illustrated, in accordance with an embodiment. The process of text summarization is distinctively divided into two parts: the screening of sentences and the subsequent clustering of sentences. The present FIG. 3 depicts the process flow 300 specifically focused on the screening of sentences. To initiate this screening process, a text article 302 may be received from a document. The text article 302 may include a plurality of sentences.

Upon receiving text article 302, one or more keywords may be extracted from the plurality of sentences based on a keyword extraction algorithm. The one or more keywords may be domain specific, and depending on the domain of the document, the one or more keywords may be extracted or identified. In some embodiments, users may also contribute to this process by providing specific keywords (referred to as user-given keywords 304).

Further, a set of additional keywords 306 corresponding to the one or more keywords may be identified from each word of the plurality of sentences, based on one of a distance calculation, a similarity algorithm, a vectorization, or a word embedding techniques.

In a more elaborative way, mere presence of the one or more keywords in a sentence may not provide semantic significance of that sentence. To measure the importance of a sentence, presence of associated set of additional keywords, for example, affinity keywords 306a, semantic significant keywords 306b, and similar keywords 306c needs to be evaluated.

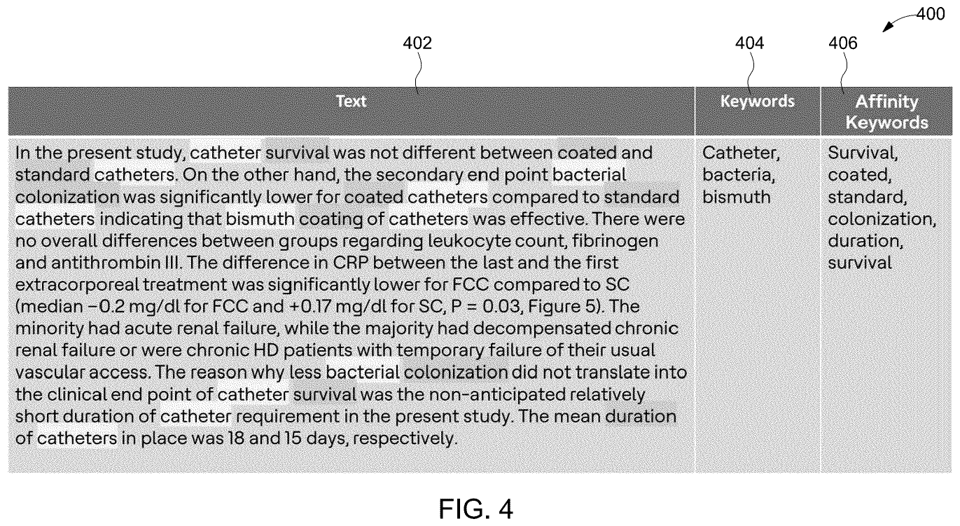

As illustrated in an exemplary Table 400 shown in FIG. 4, one or more keywords 404 are extracted from a text article 402. Beyond these one or more keywords 404, additional keywords (referred to as affinity keywords 406) are identified. Broadly, words that are closely associated with the one or more keywords may be categorized as affinity words. Although they may exhibit contextual dissimilarity, these words demonstrate a high affinity with the keywords, and hence they are term as affinity keywords 406. As depicted, affinity keywords 406 are quite different from keywords 404 contextually, but appear very closely with the keywords 404 and often serve as the subject or object of the given sentence.

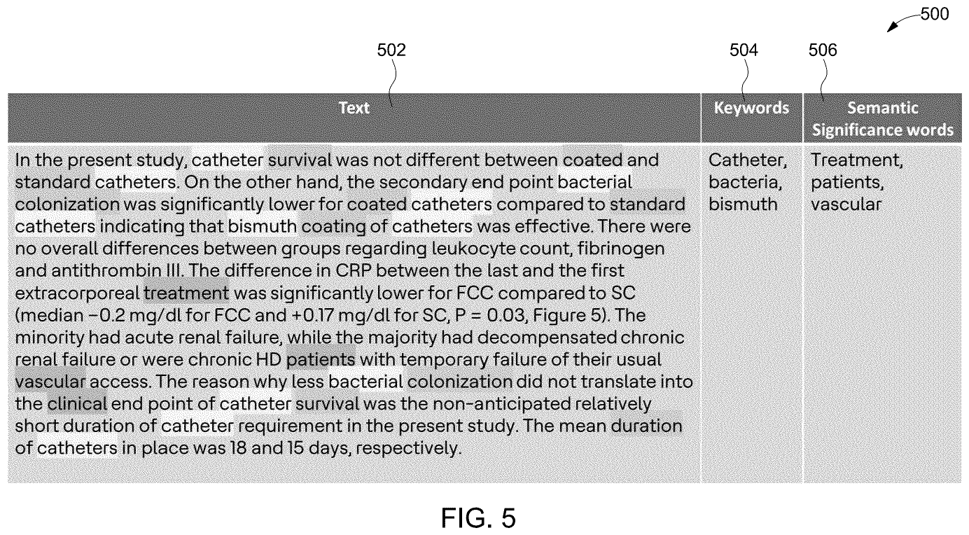

Similarly, semantic significance keywords may also be identified from the text article. For example, as illustrated in an exemplary Table 500 presented in FIG. 5, one or more keywords 504 are extracted from a text article 502. Beyond these one or more keywords 504, additional keywords (referred to as semantic significance keywords 506) are identified. Semantic significant words share semantic similarity with the one or more keywords 504 and are, therefore, also domain specific. They provide additional domain specific information which may not have been captured by the one or more keywords 504, and hence the sentences containing these semantic significance words are also considered important. As depicted, the semantic significant keywords are of the same domain as the keywords 504, although they may not exhibit contextual similarity. Their appearance in the sentence may or may not be in close proximity to the keywords 504.

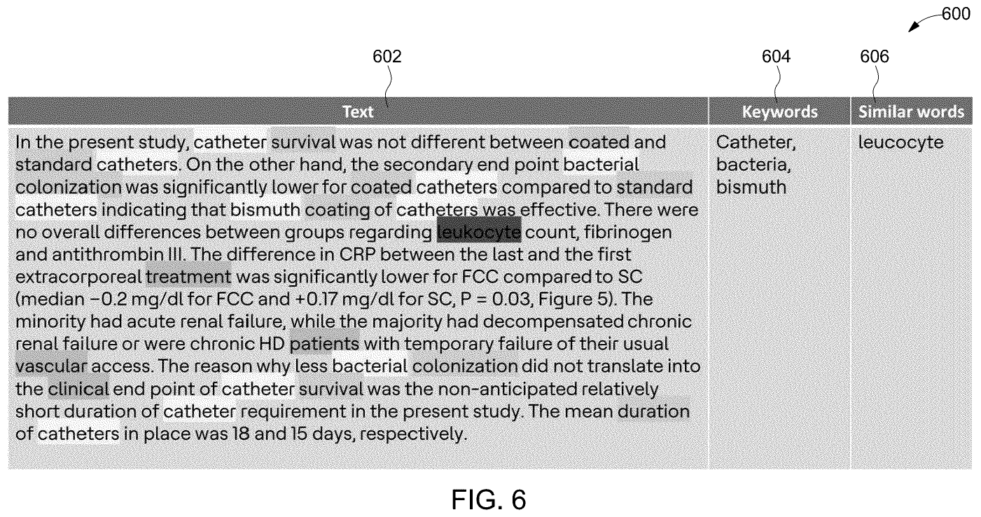

Furthermore, a set of similar keywords may also be identified from the text article. For example, as depicted in an exemplary Table 600 shown in FIG. 6, one or more keywords 604 are extracted from a text article 602. In addition to these keywords, additional keywords (referred to as similar keywords 606) are identified. Similar words are those that exhibit similarity to the keywords in terms of embedding. Through natural language processing, the embedding process ensures that similar words possess embeddings with minimal distance between them. Similar keywords 606, as depicted, closely resemble the one or more keywords 604 and generally belong to the same domain. Their appearance in the sentence may or may not be in close proximity to the keywords 604.

Once the set of additional keywords (for example, the affinity keywords 406, the semantic significance keywords 506, and the similar keywords 606) is identified, the plurality of sentences may undergo semantically scoring. This scoring is based on a weight assigned to each set of additional keywords and the frequency of each word within the plurality of sentences. Through this semantically driven scoring, a ranking is assigned to each of the plurality of sentences.

In a more elaborative way, the three sets of additional keywords (affinity keywords 406, semantic significance keywords 506, and similar keywords 606) serve as the foundation for screening the sentences. These sets of keywords are allocated programmable weights, determined by the significance of each keyword category within the domain. A mathematical formula is constructed to estimate the importance of sentences, considering a tunable weighting of each of these three categories of words. For instance, if keywords have a weight denoted as ‘k,’ affinity keywords have a weight ‘a,’ semantic words have a weight ‘s,’ and similar words have a weight ‘w,’ the semantic score for each sentence (1 to n) is computed as follows:

$$semantic score = {k}^{*} Kn + {a}^{*} An + {s}^{*} Sn + {w}^{*} Wn \qquad ( 1 )$$

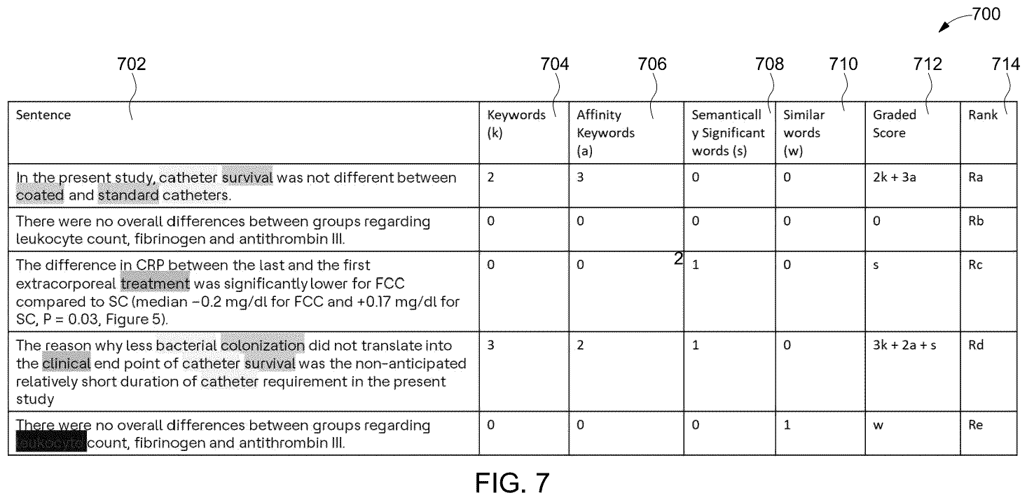

The semantic scoring of sentences is illustrated in an exemplary table 700 as shown in FIG. 7. The Table 700 presents a set of sentences 702, the weight (k) of keywords 704 for each sentence, the weight (a) of affinity keywords 706, the weight(s) of semantically significant keywords 708, the respective score 710, and the assigned rank 712. Based on priority and frequency of words, each sentence is scored with the mathematical formula represented by equation (1). This table 700 provides a clear depiction of how sentences are evaluated and ranked based on the semantic scoring.

Referring back to FIG. 3, upon scoring and ranking of the plurality of sentences, a contextual classification 308 may be performed to select a set of sentences from the plurality of sentences based on one of the semantically scoring or the ranking. The contextual classification may be one of a rule-based classification or a model-based classification.

To further elaborate, in scenarios where labelled data is unavailable, a rule-based contextual classification comes into play. In this case, sentences with ranks greater than a programmable threshold may be chosen for text summarizations. Conversely, when labelled data is available, the scored sentences may undergo labelling to create a model-based contextual classification. This model-based approach may include training of a classification model using multiple datasets, so that information related to the affinity words, semantic significant words, and similar words may be embedded into the classification model. Subsequently, this trained classification model may be deployed to identify and screen sentences in new documents that needs to be summarized. At this point, the screening process may be completed and screened sentences 310 may be obtained.

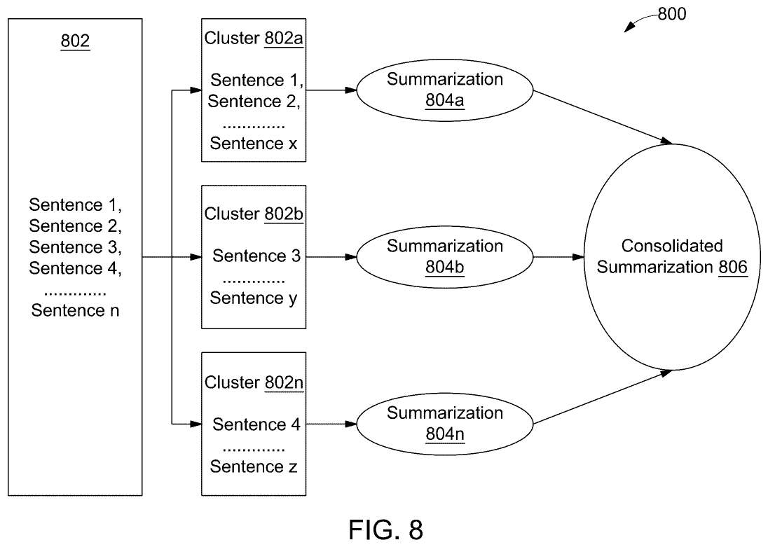

Referring now to FIG. 8, a block diagram of a process flow 800 for clustering of sentences based on semantic scoring is illustrated, in accordance with an embodiment. Upon the completion of the screening of sentences, each set of sentences may be clustered based on one of the semantic scoring or embedding. This clustering process aims to generate a summarized text for each cluster of sentences.

The need for clustering arises when the text of the article after the screening has many sentences, then summarization may not be effective. To address this, two approaches are proposed to reduce the number of sentences for summarization, ensuring minimal or no loss of contextual information. These approaches involve clustering based on semantic scores and clustering based on embedding. The present FIG. 8 specifically focuses on clustering sentences based on semantic scoring.

To initiate the clustering process, within the set of sentences 802, one or more sentences having relevant semantic scores may be identified. Based on the identifying, each of the one or more sentences may be grouped into separate clusters (e.g., cluster 802a, cluster 802b, and cluster 802n). Each of the separate cluster may include the one or more sentences with corresponding relevant semantic scores.

For example, the one or more sentences (sentence 1, sentence 2, . . . sentence x) sharing similar ranges of semantic scores may be in the cluster 802a. Similarly, the one or more sentences (sentence 3, . . . sentence y) with similar ranges of semantic scores may be in the cluster 802b. Moreover, the one or more sentences (sentence 4, . . . sentence z) with similar ranges of semantic scores may be in the cluster 802n.

Further, for each of the separate cluster a summarized text may be generated. By way of an example, a summarization text 804a may be generated for the cluster 802a. Further, a summarization text 804b may be generated for the cluster 802b. Additionally, a summarization text 804n may be generated for the cluster 802n. Further, a consolidated summarized text may be generated by concatenating the summarized text of each of the separate cluster.

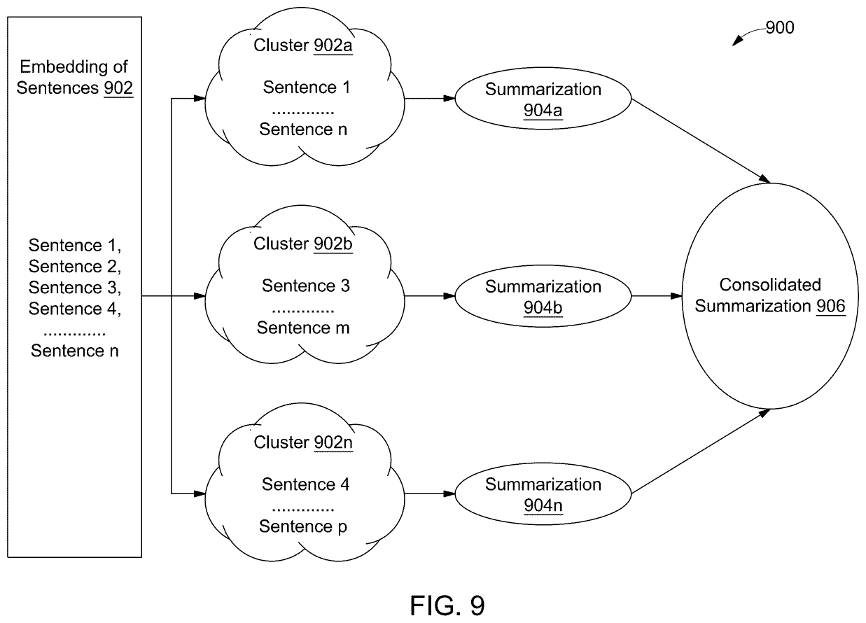

Referring now to FIG. 9, a block diagram of a process flow 900 for clustering of sentences based on embedding, in accordance with an embodiment. In this scenario, within the set of sentences 902, one or more sentences may be identified having similar embeddings.

Based on the identifying, each of the one or more sentences may be grouped into separate clusters (e.g., cluster 902a, cluster 902b, and cluster 902n). Each of the separate cluster may include the one or more sentences with corresponding relevant embeddings.

For example, the one or more sentences (sentence 1, . . . sentence n) with similar embeddings may be in the cluster 902a. Similarly, the one or more sentences (sentence 3, . . . sentence m) with similar embeddings may be in the cluster 902b. Moreover, the one or more sentences (sentence 4, . . . sentence p) with similar embeddings may be in the cluster 902n.

Further, for each of the separate cluster a summarized text may be generated. By way of an example, a summarization text 904a may be generated for the cluster 902a. Further, a summarization text 904b may be generated for the cluster 902b. Additionally, a summarization text 904n may be generated for the cluster 902n. Further, a consolidated summarized text may be generated by concatenating the summarized text of each of the separate cluster.

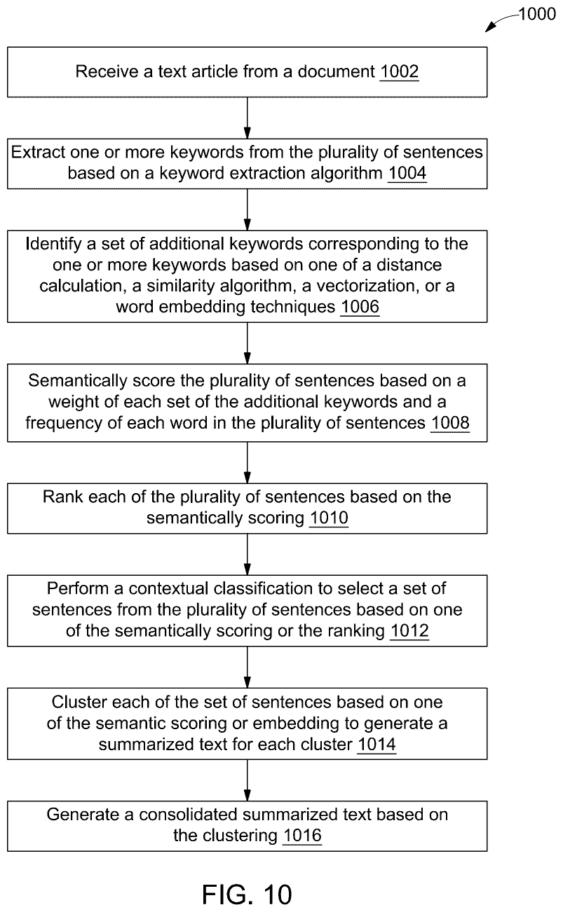

Referring now to FIG. 10, a flowchart of a method 1000 for summarizing text articles of documents is illustrated, in accordance with an embodiment. All the steps 1002-1016 may be performed by the modules 204-216 of the text summarizing device 102. Initially, at step 1002, a text article may be received from a document. The text article may include a plurality of sentences.

Once the text article is received, at step 1004, one or more keywords from the plurality of sentences may be extracted based on a keyword extraction algorithm. At step 1006, a set of additional keywords corresponding to the one or more keywords from each word of the plurality of sentences may be identified based on one of a distance calculation, a similarity algorithm, a vectorization, or a word embedding techniques. The set of additional keywords may include a plurality of affinity words, a plurality of semantically significant words, and a plurality of similar words. The set of additional keywords may provide additional information that may not be captured by the one or more keywords.

At step 1008, semantically scoring of the plurality of sentences may be done based on a weight of each set of the additional keywords and a frequency of each word in the plurality of sentences. In some embodiments, the semantically scoring may include assigning a weight to each of the set of additional keywords; and calculating a semantic score for each sentence based on the weight assigned to each of the set of additional keywords.

At step 1010, ranking of each of the plurality of sentences may be performed based on the semantically scoring. At step 1012, a contextual classification may be performed to select a set of sentences from the plurality of sentences based on one of the semantically scoring or the ranking. It should be noted that the contextual classification may be one of a rule-based classification or a model-based classification.

In one embodiment, to perform the contextual classification based on the model-based classification, the method 1000 may include for each unlabelled data, identifying the plurality of sentences having a rank greater than a predefined threshold; and selecting a set of sentences based on the identifying. The set of sentences may be selected with the rank greater than the predefined threshold.

In another embodiment, to perform the contextual classification based on the model-based classification, the method 1000 may include for each labelled data, training a model-based classification model based on the one or more keywords and the additional set of keywords; and selecting a set of sentences using the model-based classification model.

At step 1014, each of the set of sentences may be clustered based on one of the semantic scoring or embedding to generate a summarized text for each cluster.

In order to cluster each of the set of sentences based on the semantic scoring, the method 1000 may include identifying one or more sentences within the set of sentences having relevant semantic scores; and grouping each of the one or more sentences into a separate cluster based on the identifying. Each of the separate cluster may include the one or more sentences with a corresponding relevant semantic scores.

In order to cluster each of the set of sentences based on the embedding, the method 1000 may include identifying one or more sentences within the set of sentences having relevant embeddings; and grouping each of the one or more sentences into a separate cluster based on the identifying. Each of the separate cluster may include the one or more sentences with a corresponding relevant embeddings.

At step 1016, a consolidated summarized text may be generated based on the clustering. In some embodiments, in order to generate the consolidated summarized text, the method 1000 may include generating a summarized text for each of the separate cluster; and concatenating the summarized text of each of the separate cluster to obtain a consolidated summarized text.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

As will be appreciated by those skilled in the art, the techniques described in the various embodiments discussed above are not routine, or conventional, or well understood in the art. The techniques discussed above provide for summarizing text articles of documents. The incorporation of affinity keywords, semantic significant words, and similar words, alongside programmable weights, facilitates sentence screening. This leads to the identification of right set of sentences with a higher semantic relevance, contributing to a more precise summarization process. Further, the flexibility in contextual classification, offering both rule-based and model-based approaches, serves to diverse scenarios. Whether labelled data is available or not, the proposed techniques adapt, ensuring robust and adaptable performance in different summarization contexts. Further, the programmable weights assigned to different sets of keywords enable the adaptation of the summarization process to the specific requirements of different domains. This ensures that the summarization output aligns closely with the priorities of the document's domain. Further, the proposed approaches for clustering based on semantic scores and embeddings address the challenge of summarizing large documents. By segmenting the text into clusters and summarizing each cluster separately, the disclosed techniques maintain the context while ensuring efficiency. Further, the disclosed techniques ensure that the right set of sentences are given as input to the summarization model, so that the quality of the summary is as expected Furthermore, the disclosed techniques ensure that sentences for summarization are reduced, but at the same time no or minimal context should be lost.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for summarizing text articles of documents, the method comprising:
receiving, by a text summarizing device, a text article from a document, wherein the text article comprises a plurality of sentences;
extracting, by the text summarizing device, one or more keywords from the plurality of sentences based on a keyword extraction algorithm;
identifying, by the text summarizing device and from each word of the plurality of sentences, a set of additional keywords corresponding to the one or more keywords based on one of a distance calculation, a similarity algorithm, a vectorization, or a word embedding techniques;
semantically scoring, by the text summarizing device, the plurality of sentences based on a weight of each set of the additional keywords and a frequency of each word in the plurality of sentences;
ranking, by the text summarizing device, each of the plurality of sentences based on the semantically scoring;
performing, by the text summarizing device, a contextual classification to select a set of sentences from the plurality of sentences based on one of the semantically scoring or the ranking;
clustering, by the text summarizing device, each of the set of sentences based on one of the semantic scoring or embedding to generate a summarized text for each cluster; and
generating, by the text summarizing device, a consolidated summarized text based on the clustering.

2. The method of claim 1, wherein the set of additional keywords comprises a plurality of affinity keywords, a plurality of semantically significant keywords, and a plurality of similar keywords, and wherein the set of additional keywords provide additional information that is not captured by the one or more keywords.

3. The method of claim 1, wherein the semantically scoring comprises:
assigning a weight to each of the set of additional keywords; and
calculating a semantic score for each sentence based on the weight assigned to each of the set of additional keywords.

4. The method of claim 1, wherein:
the contextual classification is one of a rule-based classification or a model-based classification,
performing the contextual classification to select the set of sentences based on the rule-based classification comprises:
for each unlabelled data, identifying the plurality of sentences having a rank greater than a predefined threshold; and
selecting a set of sentences based on the identifying, wherein the set of sentences is selected with the rank greater than the predefined threshold; and
performing the contextual classification to select the set of sentences based on the model-based classification comprises:
for each labelled data, training a model-based classification model based on the one or more keywords and the additional set of keywords; and
selecting a set of sentences using the model-based classification model.

5. The method of claim 1, wherein clustering the set of sentences based on the semantic scoring comprises:
identifying one or more sentences within the set of sentences having relevant semantic scores; and
grouping each of the one or more sentences into a separate cluster based on the identifying, wherein each of the separate cluster comprises the one or more sentences with a corresponding relevant semantic scores.

6. The method of claim 1, wherein clustering the set of sentences based on the embedding comprises:
identifying one or more sentences within the set of sentences having relevant embeddings; and
grouping each of the one or more sentences into a separate cluster based on the identifying, wherein each of the separate cluster comprises the one or more sentences with a corresponding relevant embeddings.

7. The method of claim 6, wherein generating the consolidated summarized text comprises:
generating a summarized text for each of the separate cluster; and
concatenating the summarized text of each of the separate cluster to obtain a consolidated summarized text.

8. A system for summarizing text articles of documents, the system comprising:
a processor and a memory communicatively coupled to the processor, wherein the memory stores processor-executable instructions, which, on execution, causes the processor to:
receive a text article from a document, wherein the text article comprises a plurality of sentences;
extract one or more keywords from the plurality of sentences based on a keyword extraction algorithm;
identify, from each word of the plurality of sentences, a set of additional keywords corresponding to the one or more keywords based on one of a distance calculation, a similarity algorithm, a vectorization, or a word embedding techniques;
semantically score the plurality of sentences based on a weight of each set of the additional keywords and a frequency of each word in the plurality of sentences;
rank each of the plurality of sentences based on the semantically scoring;
perform a contextual classification to select a set of sentences from the plurality of sentences based on one of the semantically scoring or the ranking;
cluster each of the set of sentences based on one of the semantic scoring or embedding to generate a summarized text for each cluster; and
generate a consolidated summarized text based on the clustering.

9. The system of claim 8, wherein the set of additional keywords comprises a plurality of affinity keywords, a plurality of semantically significant keywords, and a plurality of similar keywords, and wherein the set of additional keywords provide additional information that is not captured by the one or more keywords.

10. The system of claim 8, wherein to semantically scoring the plurality of sentences the processor instructions, on execution, further cause the processor to:
assign a weight to each of the set of additional keywords; and
calculate a semantic score for each sentence based on the weight assigned to each of the set of additional keywords.
